(19) United States
(12) Patent Application Publication
(10) Pub. No.: US 2024/0205766 A1
(43) Pub. Date: Jun. 20, 2024

(54) L1/L2 TRIGGERED MOBILITY EXECUTION

(71) Applicant: Samsung Electronics Co., Ltd., Suwon-si (KR)

(72) Inventor: Shiyang Leng, Allen, TX (US)

(21) Appl. No.: 18/522,115

(22) Filed: Nov. 28, 2023

Related U.S. Application Data
(60) Provisional application No. 63/432,914, filed on Dec. 15, 2022.
(60) Provisional application No. 63/437,542, filed on Jan. 6, 2023.

(51) Int. Cl. H04W 36/00; H04W 36/08; H04W 36/36

(52) U.S. Cl. CPC H04W 36/0079; H04W 36/08; H04W 36/362

(57) ABSTRACT

Methods and apparatuses for a L1/L2 triggered mobility execution in a wireless communication system are provided. The method of UE comprises: receiving information related to (i) an LTM configuration and (ii) an applicability of the LTM configuration to recover from a failure of an LTM execution; determining whether the applicability of the LTM configuration to recover from the failure of the LTM execution is enabled; determining whether the LTM execution fails; performing a cell selection operation based on a determination that the LTM execution fails; determining whether a cell that is selected in the cell selection operation is an LTM candidate cell; performing the LTM execution based on a determination that the cell is an LTM candidate cell and the applicability of the LTM configuration to recover from the failure of the LTM execution is enabled; applying the LTM configuration and transmitting a random access preamble.

### CROSS-REFERENCE TO RELATED APPLICATIONS AND CLAIM OF PRIORITY

The present application claims priority under 35 U.S.C. § 119(e) to U.S. Provisional Patent Application No. 63/432,914, filed on Dec. 15, 2022; and U.S. Provisional Patent Application No. 63/437,542, filed on Jan. 6, 2023, which are hereby incorporated by reference in their entirety.

### TECHNICAL FIELD

The present disclosure relates generally to wireless communication systems and, more specifically, the present disclosure relates to a layer 1/layer 2 (L1/L2) triggered mobility execution in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to a L1/L2 triggered mobility execution in a wireless communication system.

In one embodiment, a user equipment (UE) is provided in a wireless communication system. The UE comprises a transceiver configured to receive information related to (i) LTM configuration and (ii) an applicability of the LTM configuration to recover from a failure of an LTM execution. The UE further comprises a processor operably coupled to the transceiver, the processor configured to: determine, based on the information, whether the applicability of the LTM configuration to recover from the failure of the LTM execution is enabled, determine whether the LTM execution fails, perform a cell selection operation based on a determination that the LTM execution fails, determine, based on the LTM configuration, whether a cell that is selected in the cell selection operation is an LTM candidate cell, perform the LTM execution to the cell based on a determination that the cell is an LTM candidate cell and a determination that the applicability of the LTM configuration to recover from the failure of the LTM execution is enabled, and apply the LTM configuration for the cell, wherein the transceiver is further configured to transmit, to the cell, a random access preamble for performing a random access procedure.

In another embodiment, a method of a UE is provided in a wireless communication system, The method comprises: receiving information related to (i) a LTM configuration and (ii) an applicability of the LTM configuration to recover from a failure of an LTM execution; determining, based on the information, whether the applicability of the LTM configuration to recover from the failure of the LTM execution is enabled; determining whether the LTM execution fails; performing a cell selection operation based on a determination that the LTM execution fails; determining, based on the LTM configuration, whether a cell that is selected in the cell selection operation is an LTM candidate cell; performing the LTM execution to the cell based on a determination that the cell is an LTM candidate cell and a determination that the applicability of the LTM configuration to recover from the failure of the LTM execution is enabled; applying the LTM configuration for the cell; and transmitting, to the cell, a random access preamble for performing a random access procedure.

In yet another embodiment, a base station (BS) is provided in a wireless communication system. The BS comprises a processor configured to generate information indicating whether an applicability of an LTM configuration to recover from a failure of an LTM execution is enabled is determined; and a transceiver configured to transmit the information related to (i) the LTM configuration and (ii) the applicability of the LTM configuration to recover from the failure of an LTM execution, wherein: whether the LTM execution fails is determined, a cell selection operation is performed based on a determination that the LTM execution fails, based on the LTM configuration, whether a cell that is selected in the cell selection operation is an LTM candidate cell is determined, the LTM execution is performed to the cell based on a determination that the cell is the LTM candidate cell and a determination that the applicability of the LTM configuration to recover from the failure of the LTM execution is enabled, the LTM configuration for the cell is applied, and a random access preamble is transmitted to the cell for performing a random access procedure.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIG. 6 illustrates a flowchart of UE behavior on handling the LTM execution timer according to embodiments of the present disclosure;

FIG. 7A illustrates a flowchart of UE behavior when the UE receives one or more HO commands according to embodiments of the present disclosure;

FIG. 7B illustrates a flowchart of UE behavior when the UE receives one or more HO commands according to embodiments of the present disclosure; and

FIG. 8 illustrates a flowchart of UE method for a L1/L2 triggered mobility execution according to embodiments of the present disclosure.

### DETAILED DESCRIPTION

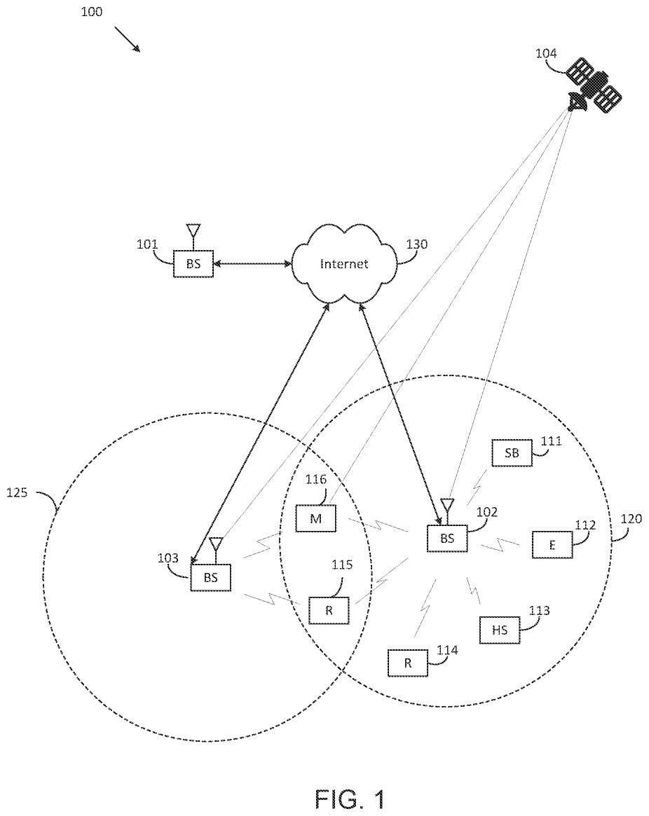

FIG. 1 through FIG. 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TR 38.811 v15.2.0, “Study on NR to support non-terrestrial networks”; 3GPP TR 38.821 v16.0.0, “Solutions for NR to support non-terrestrial networks (NTN)”; 3GPP TS 38.300 v17.2.0, “5G; NR; NR and NG-RAN Overall description; Stage-2”; 3GPP TS 38.331 v17.2.0, “5G; NR; Radio Resource Control (RRC); Protocol specification”; 3GPP TS 38.306 v17.2.0, “5G; NR; User Equipment (UE) radio access capabilities”; 3GPP, TS 38.304 v17.5.0, 5G; “NR; User Equipment (UE) procedures in idle mode and in RRC Inactive state”; and 3GPP TS 38.321 v17.2.0, 5G; NR; Medium Access Control (MAC) protocol specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably-arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of UEs within a coverage area 120 of the gNB 102. The first plurality of UEs includes a UE 111, which may be located in a small business; a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M), such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3GPP NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As discussed in greater detail below, the wireless network 100 may have communications facilitated via one or more communication satellite(s) 104 that may be in obit over the earth. The communication satellite(s) 104 can communicate directly with the BSs 102 and 103 to provide network access, for example, in situations where the BSs 102 and 103 are remotely located or otherwise in need of facilitation for network access connections beyond or in addition to traditional fronthaul and/or backhaul connections. Various of the UEs (e.g., as depicted by UE 116) may be capable of at least some direct communication and/or localization with the communication satellite(s) 104, for example, to receive positional information or coordinates.

An NTN refers to a network, or segment of networks using RF resources on board a communication satellite (or unmanned aircraft system platform) (e.g., communication satellite(s) 104). Considering the capabilities of providing wide coverage and reliable service, an NTN is envisioned to ensure service availability and continuity ubiquitously. For instance, an NTN can support communication services in unserved areas that cannot be covered by conventional terrestrial networks, in underserved areas that are experiencing limited communication services, for devices and passengers on board moving platforms, and for future railway/maritime/aeronautical communications, etc.

As described in more detail below, one or more of the UEs 111-116 include circuitry, programing, or a combination thereof, for utilizing a L1/L2 triggered mobility execution in a wireless communication system. In certain embodiments, and one or more of the gNBs 101-103 includes circuitry, programing, or a combination thereof, to support a L1/L2 triggered mobility execution in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

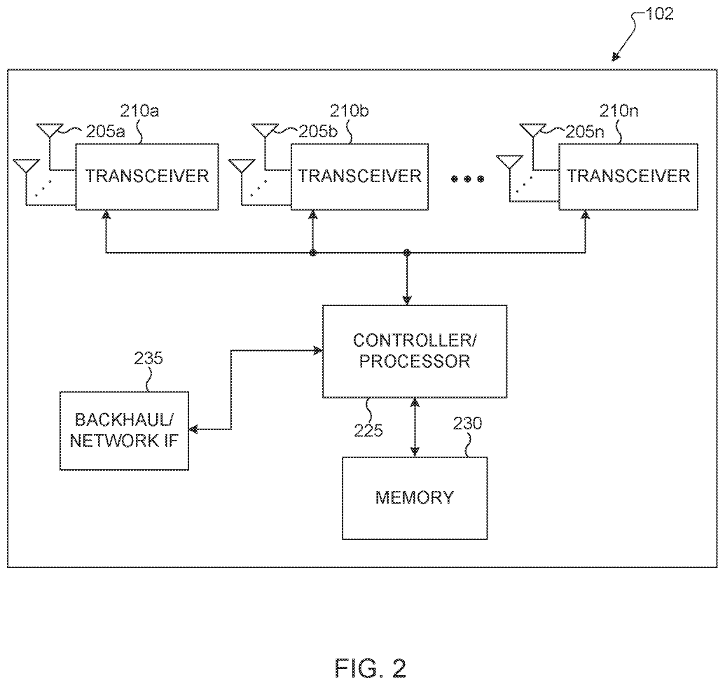

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process. The controller/processor 225 is also capable of executing programs and other processes resident in the memory 230, such as processes to support a L1/L2 triggered mobility execution in a wireless communication system.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

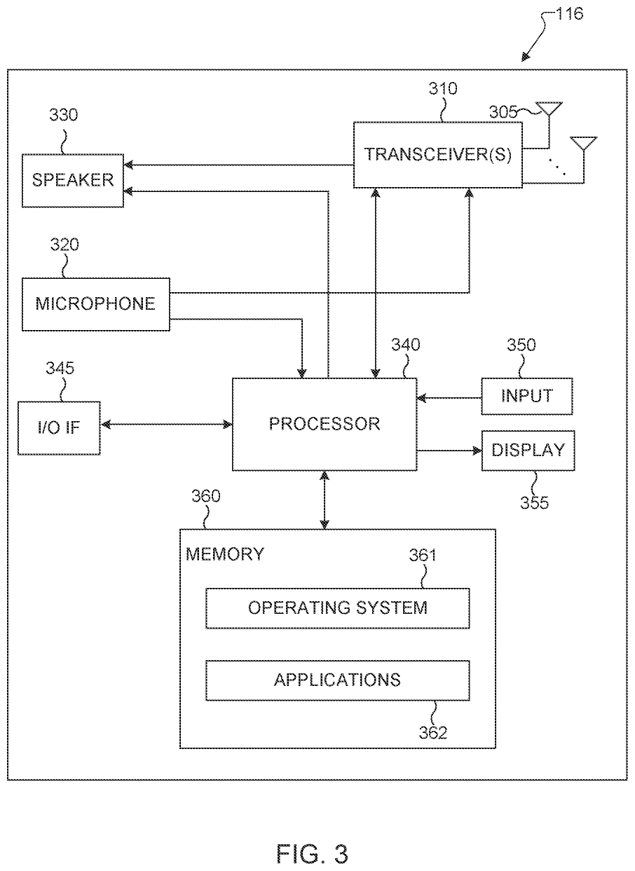

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for utilizing a L1/L2 triggered mobility execution in a wireless communication system. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

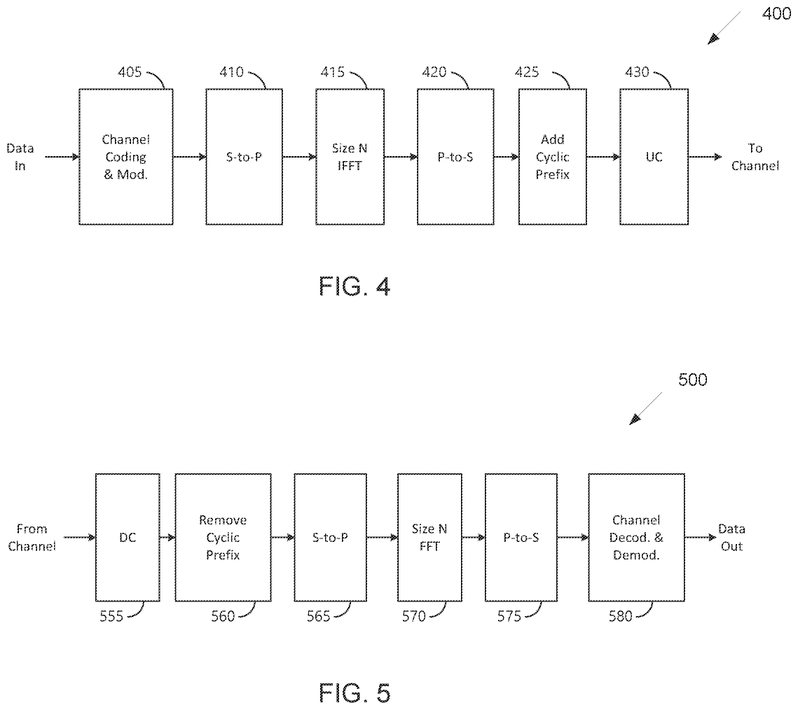

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support a L1/L2 triggered mobility execution in a wireless communication system as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the down-converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 515 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

3GPP has developed technical specifications and standards to define the new 5G radio-access technology, known as 5G NR. Mobility handling is a critical aspect in any mobile communication system including 5G system. For a UE in a connected mode, mobility is controlled by the network with the assistance from the UE to maintain a good quality of connection. Based on the measurement on radio link quality of the serving cell and neighboring cell(s) reported by the UE, the network may hand over the UE to a neighboring cell that can provide better radio conditions when the UE is experiencing a degraded connection to the serving cell. In release-15 NR, the basic mechanism and procedure of network-controlled mobility in a connected mode is developed. In release-16 NR, enhancements to network-controlled mobility in a connected mode are introduced to mitigate connection interruption during handover procedure. Specifically, two enhanced handover mechanisms are developed, known as conditional handover (CHO) and dual active protocol stack (DAPS).

For mobility in a connected mode, the handover is initiated by the network via higher layer signaling, e.g., RRC message, based on L3 measurements. However, this procedure involves more latency, signaling overhead and interruption time that may become the key issue in some scenarios with frequent handover, e.g., a UE in high-speed vehicular and in FR2 deployment. Reduction on overhead and/or latency and interruption time in handover procedure is necessary. This brings the need of L1/L2 (Layer 1/Layer 2) triggered mobility (LTM), by which handover can be triggered by L1/L2 signaling based on L1 measurement. More specifically, LTM refers to a mobility mechanism that UE switches from the source cell to a target cell with beam switching triggered by L1/L2 signaling, where the beam switching decision is based on L1 measurement on beams among neighboring cells.

When LTM is initiated, how the UE execute LTM and how the UE handles the coexistence of L3 mobility, CHO, and LTM are desired to be specified.

In the present disclosure, how the UE execute LTM is provided while taking into account the L3 mobility and CHO. Specifically, the UE behavior regarding the timer for LTM execution and the UE behavior to handle the coexistence of different HO mechanisms and LTM failure recovery are specified.

The UE executes LTM upon receiving the LTM MAC CE. In order to supervise the execution of LTM to the target cell, a timer with a duration parameter can be configured in an RRC message (e.g., RRCReconfiguration) for the LTM configuration, namely LTM execution timer.

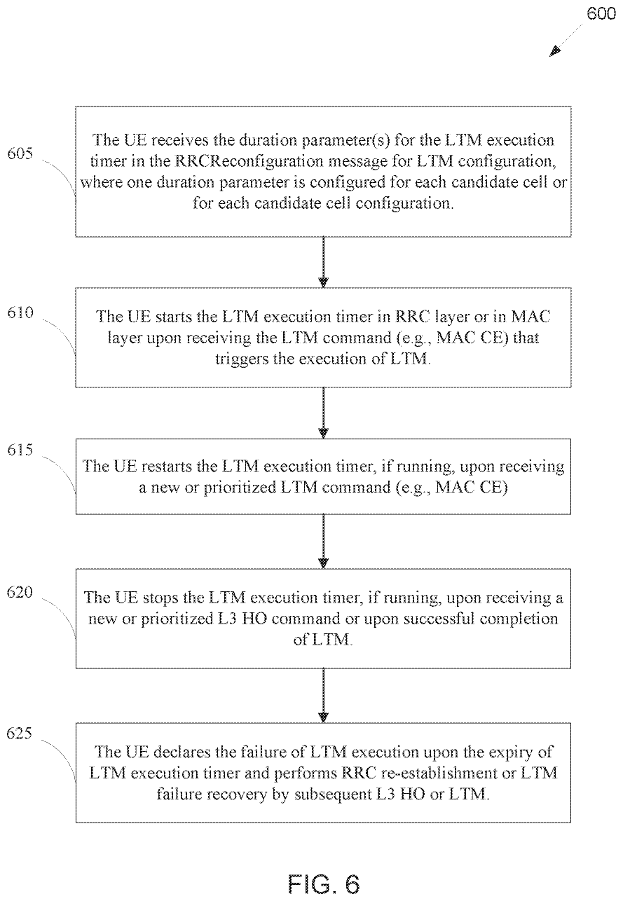

FIG. 6 illustrates a flowchart of UE method 600 on handling the LTM execution timer according to embodiments of the present disclosure. The UE method 600 as may be performed by a UE (e.g., 111-116 as illustrated in FIG. 1). An embodiment of the UE method 600 shown in FIG. 6 is for illustration only. One or more of the components illustrated in FIG. 6 can be implemented in specialized circuitry configured to perform the noted functions or one or more of the components can be implemented by one or more processors executing instructions to perform the noted functions.

FIG. 6 shows an embodiment of UE behavior on handling the LTM execution timer. At step 605, the UE receives the duration parameter(s) for the LTM execution timer in an RRC message (e.g., RRCReconfiguration) for LTM configuration. In one example, each candidate cell is configured with a duration parameter, i.e., one timer duration is associated with one candidate cell ID. In another example, each candidate cell configuration is configured with a duration parameter, i.e., one timer duration is associated with one candidate cell configuration ID. In one example, the timer can be configured with different durations respectively for LTM execution with a random access procedure and for LTM execution with RACH-less operation.

At step 610, the UE starts the LTM execution timer upon receiving the LTM command (e.g., MAC CE) that triggers the execution of LTM. In one example, the LTM execution timer is maintained in the MAC layer. In another example, the LTM execution timer is maintained in the RRC layer. In this case, the MAC layer sends an indication to the RRC layer to start the LTM execution timer.

At step 615, the UE restarts the LTM execution timer, if running, upon receiving a new or prioritized LTM command (e.g., MAC CE).

At step 620, the UE stops the LTM execution timer, if running, upon receiving a new or prioritized L3 HO command or upon successful completion of random access procedure for the target cell of LTM or upon successful reception of a PDCCH transmission addressed to the C-RNTI from the target cell in case of RACH-less LTM or upon successful reception of an acknowledgement (e.g., in MAC CE, or DCI, or RRC message) from the target cell in case of RACH-less LTM.

At step 625, the UE declares the failure of LTM execution upon the expiry of LTM execution timer and performs RRC re-establishment or LTM failure recovery.

In one embodiment of LTM failure recovery, the UE can be configured to attempt to recovery by using the stored configuration of LTM candidate cells. In one example, the UE performs cell (re)-selection upon LTM failure. If configured to recovery through LTM candidate cells, and if the selected cell is one of the LTM candidate cells, the UE applies the stored LTM configuration for the selected cell, and the UE performs random access procedure to that cell, or if the UE has already obtained UL synchronization to that cell, the UE performs RACH-less switch to that cell. For cell (re)-selection, the UE can prioritize (i.e., select a suitable cell from) the LTM candidate cells. In another example, the UE can prioritize (i.e., select a suitable cell from) the LTM candidate cells for which the UE has obtained UL synchronization in cell reselection.

In one example, the UE can prioritize (i.e., select a suitable cell from) those LTM candidate cells whose L1 measurement results (e.g., L1-RSRP) are available or better than a configured threshold in cell reselection. In yet another example, the UE can select the cell with best L1 measurement result (e.g., L1-RSRP) among the prioritized cells. When performing cell (re)-selection upon LTM failure, if multiple cells are selected in cell (re)-selection, the UE can choose one cell up to UE implementation; or the UE can choose the one whose L1 measurement result (e.g., L1-RSRP) for LTM is available and/or is the best; or the UE can prioritize the ones for which the UE has obtained UL synchronization for LTM, or the ones which are configured as a candidate cell for LTM.

In one embodiment, in case of LTM failure, the UE can reserve the other HO command(s) received before or during an HO execution, which can be L3 HO command or LTM command but are not executed. In one example, the UE can be configured by RRC signaling (e.g., RRCReconfiguration) to enable the reserving of HO command(s). If pre-defined or enabled by configuration, the UE can reserve the HO command(s) by storing the associated HO execution information (e.g., target cell ID, target cell configuration, cell/beam switch related information) in one or more UE variables.

Upon the LTM failure at step 625, the UE can subsequently execute one of the reserved HO commands (e.g., L3 HO command or LTM command) according to the stored HO execution information. If multiple HO commands (e.g., L3 HO command or LTM command) are reserved, the UE can choose to execute one of the reserved HO command(s) up to UE implementation; and/or the UE can choose to execute the LTM command; and/or the UE can choose to execute the one with the target cell for which the UL synchronization is obtained; and/or the UE can choose to execute the one with the target cell for which the L1 measurement result (e.g., L1-RSRP) is the best or better than a configured threshold. If the LTM is successfully completed at step 620, i.e., LTM failure does not happen, the UE releases the reserved HO commands upon the LTM completion.

In one embodiment, if the UE receives a second HO command (e.g., L3 HO command or LTM command) before starting the timer for the execution of the first HO command (e.g., T304 timer for L3 HO command or LTM execution timer for LTM command) or before the execution of the first HO command, the UE executes the second HO command, starts the corresponding timer, and ignores/reserves the first HO command.

In another embodiment, if the UE receives a second HO command (e.g., L3 HO command or LTM command) before starting the timer for the execution of the first HO command (e.g., T304 timer for L3 HO command or LTM execution timer for LTM command) or before the execution of the first HO command, the UE executes the first HO command, starts the corresponding timer, and ignores/reserves the second HO command.

In yet another embodiment, if the UE receives a second HO command (e.g., L3 HO command or LTM command) before starting the timer for the execution of the first HO command (e.g., T304 timer for L3 HO command or LTM execution timer for LTM command) or before the execution of the first HO command, the UE executes the prioritized HO command, starts the corresponding timer, and ignores/reserves the other HO command. In one example, the LTM command is always prioritized. In another example, the L3 HO command is always prioritized. In an alternative example, the prioritization between LTM and L3 HO is pre-configured by an RRC message (e.g., RRCReconfiguration). In one another example, either the first HO command or the second HO command is prioritized with an indication in the corresponding HO command.

In one embodiment, if the UE receives a second HO command (e.g., L3 HO command or LTM command) when the timer for the execution of the first HO command (e.g., T304 timer for L3 HO command or LTM execution timer for LTM command) is running and before starting to synchronize to the target cell for the first HO command, the UE ignores/reserves the second HO command, and continues executing the first HO command.

In another embodiment, if the UE receives a second HO command (e.g., L3 HO command or LTM command) when the timer for the execution of the first HO command (e.g., T304 timer for L3 HO command or LTM execution timer for LTM command) is running and before starting to synchronize to the target cell for the first HO command, the UE stops the current running timer, starts/restarts the timer for the second HO command, and executes the second HO command.

In yet another embodiment, if the UE receives a second HO command (e.g., L3 HO command or LTM command) when the timer for the execution of the first HO command (e.g., T304 timer for L3 HO command or LTM execution timer for LTM command) is running and before starting to synchronize to the target cell for the first HO command, the UE executes the prioritized HO command if the prioritization between the L3 HO and the LTM is pre-defined/configured or if the priority for one of the HO commands is indicated. In one example, the prioritization between the L3 HO and the LTM can be configured by an RRC message (e.g., RRCReconfiguration). In another example, the priority for one HO command can be indicated in the HO command (e.g., L3 HO command or LTM command). If the first HO command is prioritized, the UE ignores/reserves the second HO command and continues executing the first HO command. If the second HO command is prioritized, the UE stops the current running timer, starts/restarts the timer for the second HO command, and executes the second HO command.

In one embodiment, in the case that the UE needs to stop the current running T304 timer in RRC layer for the L3 HO execution command and to start/restart the LTM execution timer in MAC layer for the LTM command, the MAC layer sends an indicate to the RRC layer to stop the execution of the L3 HO and the current running T304 timer after receiving the LTM command and before the start of the LTM execution timer. In the case that the UE needs to stop the current running LTM execution timer in MAC layer for the LTM execution command and to start/restart the T304 timer in RRC layer for the L3 HO command, the RRC layer sends an indicate to the MAC layer to stop the execution of the LTM execution and the current running LTM execution timer after receiving the L3 HO command and before the start of the T304 timer.

In one embodiment, in the case that the UE receives the conditional configuration for CHO and starts to evaluate the CHO execution conditions (i.e., trigger events), before any CHO execution is fulfilled, upon reception of LTM command, the UE executes the LTM to switch to the target cell regardless of any previously received CHO configuration and evaluation.

In another embodiment, in the case that the UE successfully completes the cell switch to the target cell by LTM operation, the UE releases the stored CHO configuration, if any, upon the completion of the LTM. In an alternative embodiment, in the case that the UE successfully completes the cell switch to the target cell by LTM operation, the UE maintains the stored CHO configuration, if any, upon the completion of the LTM. In one example, the UE can maintain the CHO configuration for all candidate cells if pre-defined or configured by RRC or indicated in MAC CE. In another example, the UE can maintain the CHO configuration for certain candidate cells. For which candidate cells the CHO configuration is maintained can be indicated in an RRC message (e.g., RRCReconfiguration) containing the CHO configuration and/or the LTM configuration, or can be indicated in LTM command (e.g., MAC CE).

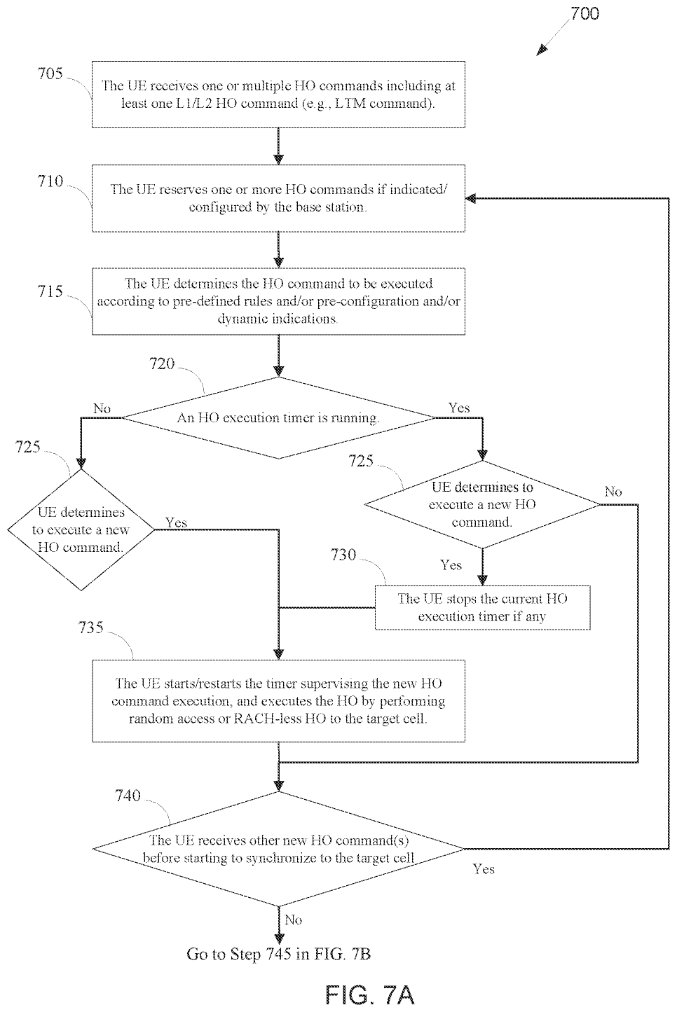

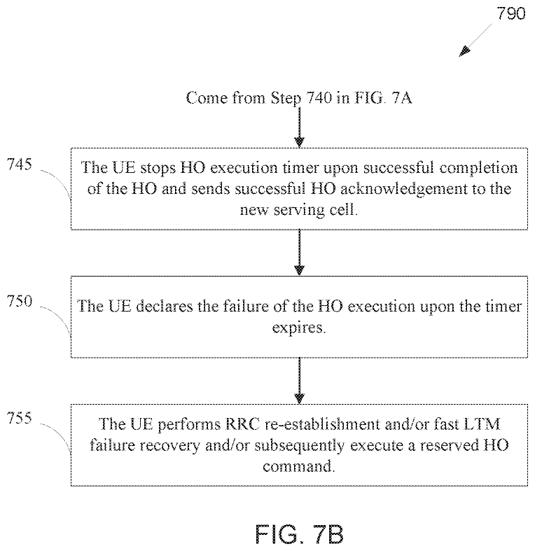

FIG. 7A illustrates a flowchart of UE method 700 when the UE receives one or more HO commands according to embodiments of the present disclosure. The UE method 700 as may be performed by a UE (e.g., 111-116 as illustrated in FIG. 1). An embodiment of the UE method 700 shown in FIG. 7A is for illustration only. One or more of the components illustrated in FIG. 7A can be implemented in specialized circuitry configured to perform the noted functions or one or more of the components can be implemented by one or more processors executing instructions to perform the noted functions.

FIG. 7B illustrates a flowchart of UE method 790 when the UE receives one or more HO commands according to embodiments of the present disclosure. The UE method 790 as may be performed by a UE (e.g., 111-116 as illustrated in FIG. 1). An embodiment of the UE method 790 shown in FIG. 7B is for illustration only. One or more of the components illustrated in FIG. 7B can be implemented in specialized circuitry configured to perform the noted functions or one or more of the components can be implemented by one or more processors executing instructions to perform the noted functions.

As illustrated in FIG. 7A, the step 740 in FIG. 7A is connected to the step 745 in FIG. 7B.

FIGS. 7A and 7B illustrate one embodiment of UE behavior when one or more HO commands (L3 HO command and L1/L2 HO command, e.g., LTM command) are received.

At step 705, the UE can receive one or multiple HO commands including at least one LTM commands. The HO commands can be L1/L2 HO command(s) (e.g., LTM command) and L3 HO command(s) simultaneously or sequentially received in PDCCH and/or PDSCH.

At step 710, if indicated/configured to reserve a received HO command, the UE can reserve the HO command and stores the information contained in the HO command in a UE variable. Alternatively, for step 710, the UE can reserve all HO commands received from the source cell before disconnecting to the source cell and/or before starting to synchronize to the target cell.

To enable the reservation/storage of HO command(s), the HO command can include an indication. For example, the L3 HO command can include a field in the RRCReconfiguration message to indicate the HO command needs to be reserved by the UE; the LTM command can include a field in the MAC CE to indicate the LTM command needs to be reserved by the UE.

To reserve/store/accumulate the information contained in the HO command(s), a UE variable can be used. The UE variable can include the list of received HO command(s) and each entry of the list includes the information contained in the corresponding HO command. If the HO command is indicated to be reserved/stored, the UE stores the HO command and the associated information in the variable.

The information in each HO command to be stored may include, for example, the target cell ID, the target cell configuration, the associated execution timer parameters (e.g., timer duration), the cell/beam switch related information (e.g., TCI states ID), etc. The information in each HO command may also include the priority for execution. In one example, a HO command can include a priority level indication, e.g., a smaller priority level number indicates a higher priority, i.e., priority level 1 indicates a higher priority than priority level 2. The UE can store the priority level associated with the HO command.

In another example, a HO command can include a prioritized state and the priority state enabled indicates the execution of that HO command is prioritized than other HO commands without the prioritized state enabled. The UE can update the prioritized state for all stored HO command(s) when a new HO command with a priority state enabled is received. The UE can prioritize the latest received HO command with a prioritized state enabled, i.e., the prioritization of the latest received HO command(s) with a prioritized state enabled overrides the prioritization of previously received HO command(s) with a prioritized state enabled.

At step 715, the UE determines the HO command to be executed from all received HO command(s) according to pre-defined rules and/or pre-configuration and/or indications.

In one example, upon the receiving the first HO command from the source cell, the UE determines to execute the first received HO command and ignores the other HO command(s) received later during the execution of the first HO command.

In another example, upon the receiving the first HO command from the source cell, the UE determines to execute the first received HO command. For any HO commands that are received later than the first HO command and before starting the timer for the execution of the first HO command or before the execution of the first HO command or before disconnecting to the source cell or before starting to synchronize to the target cell, the UE reserves the HO command(s) and stores the associated information if the HO command(s) is indicated to be reserved.

In one example, after the receiving the first HO command from the source cell, if the UE receives other HO command(s) before starting the timer for the execution of the first HO command or before the execution of the first HO command or before disconnecting to the source cell or before starting to synchronize to the target cell, the UE determines to execute the latest received HO command. The UE can ignore the first HO command and any other HO command(s); alternatively, the UE can reserve any HO commands if indicated to be reserved, including the first HO command.

In yet another embodiment, after the receiving the first HO command from the source cell, if the UE receives other HO command(s) before starting the timer for the execution of the first HO command or before the execution of the first HO command or before disconnecting to the source cell or before starting to synchronize to the target cell, the UE determines to execute the prioritized HO command among all received HO commands. The UE can ignore the first HO command and any other HO command(s); alternatively, the UE can reserve any HO commands if indicated to be reserved, including the first HO command.

To determine the prioritized HO command, for one example, if priority level is indicated in HO command(s), the UE determines to execute the HO command with the highest priority. In another example, if a prioritization state is enabled in HO command(s), the UE determines to execute the HO command with the prioritization state enabled. The UE can prioritize the latest received HO command with a prioritized state enabled, i.e., the prioritization of the latest received HO command(s) with the prioritized state enabled overrides the prioritization of previously received HO command(s) with the prioritized state enabled.

In yet another example to determine the prioritized HO command, the UE follows pre-defined rules. Examples includes one or more of the followings: (1) L1/L2 HO commands (e.g., LTM command) are prioritized than L3 HO commands; (2) L3 HO commands are prioritized than L1/L2 HO commands (e.g., LTM command); and/or (3) among multiple L1/L2 HO commands (e.g., LTM command), the HO command for a target cell with one or more conditions fulfilled is prioritized. One condition can be the UE has synchronized to the corresponding target cell. One another condition can be the timer for maintaining the UL synchronization (e.g., TimeAlignmentTimer) to the target cell is running, and/or running with the longest remaining duration. One another condition can be the L1 measurement result (e.g., L1-RSRP value) for the target cell is the best among all target cells, and/or is better than a threshold.

At step 720 and step 725, the UE checks whether an HO command is being executed (i.e., the HO execution timer is running) and whether a new HO command is determined to be executed.

If the UE determines to execute a new HO command, the UE stops the current HO execution timer if any is running (i.e., step 730), and starts/restarts the timer supervising the new HO command execution and executes the HO by performing random access or RACH-less HO to the target cell (i.e., step 735). Otherwise, (i.e., if there is a timer running for an HO execution and the UE determines not to execute a new HO command), the UE continues the current HO execution and maintains the current HO execution timer.

At step 730 and step 735, in the case that the current running timer supervising an HO execution is controlled by RRC layer and the UE determines to execute a new L1/L2 HO command (e.g., LTM command) for which a timer controlled by a MAC layer is to be started, the UE receives an indication of L1/L2 HO execution (e.g., LTM execution) from lower layers (e.g., MAC layer) and stops the current timer in an RRC layer. In another example, if the current running timer supervising an HO execution is controlled by MAC layer and the UE determines to execute a new L3 HO command for which a timer controlled by RRC layer is to be started, the UE receives an indication of L3 HO execution from RRC layers and stops the current timer in MAC layer. In one example, if the UE determines to execute a new L1/L2 HO command (e.g., LTM command) for which a timer controlled by RRC layer is to be started, the UE stops the current running timer in RRC layer if any and starts a new RRC timer to supervise the L1/L2 HO execution (e.g., LTM execution). And the RRC layer and the lower layers (e.g., MAC layer and/or PHY layer) exchanges information for the start/stop/expiry of the RRC timer.

At step 745, if no new HO command is received before disconnecting the source cell or before starting to synchronize to the target cell, the UE continues the current HO execution, stops the associated timer upon successful completion of the HO, and sends successful HO acknowledgement to the new serving cell (i.e., the target cell of the HO). Upon the successful completion of the HO, the UE can release the reserved HO command(s) if any and remove the associated information in the stored variable.

Upon the HO execution timer expires, the UE declares the HO is failed (i.e., step 750) and performs RRC re-establishment and/or HO failure recovery (e.g., LTM failure recovery) and/or subsequently executes a reserved HO command, i.e., step 755. The UE can determine to execute a reserved HO command as aforementioned in step 715. Upon the successful HO failure recovery and/or upon the successful connection (re)-establishment and/or upon the successful execution of a subsequent HO command, the UE can release the reserved HO command(s) if any and remove the associated information in the stored variable.

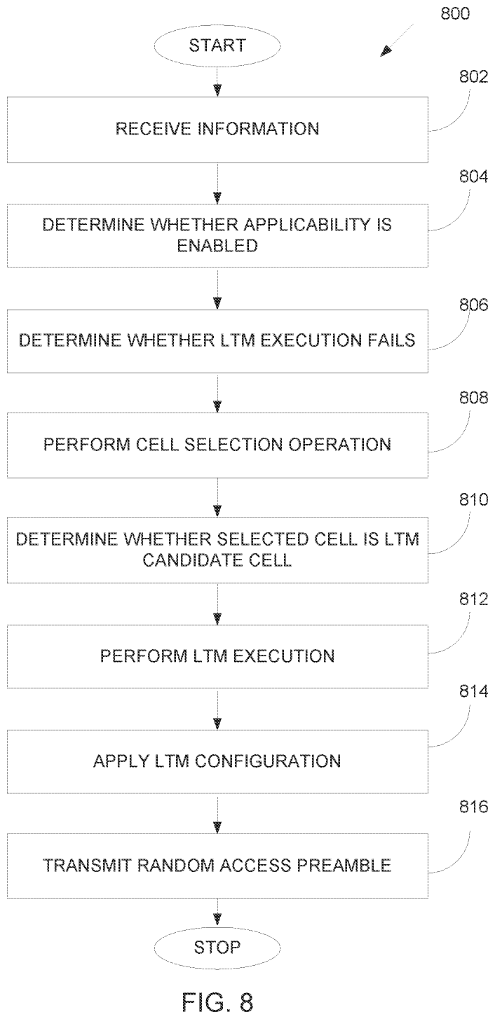

FIG. 8 illustrates a flowchart of UE method 800 for a L1/L2 triggered mobility execution according to embodiments of the present disclosure. The UE method 800 as may be performed by a UE (e.g., 111-116 as illustrated in FIG. 1). An embodiment of the UE method 800 shown in FIG. 8 is for illustration only. One or more of the components illustrated in FIG. 8 can be implemented in specialized circuitry configured to perform the noted functions or one or more of the components can be implemented by one or more processors executing instructions to perform the noted functions.

As illustrated in FIG. 8, the UE method 800 begins at step 802. In step 802, a UE receives information related to (i) an LTM configuration and (ii) an applicability of the LTM configuration to recover from a failure of an LTM execution.

In step 804, the UE determines, based on the information, whether the applicability of the LTM configuration to recover from the failure of the LTM execution is enabled.

In step 806, the UE determines whether the LTM execution fails.

In step 808, the UE performs a cell selection operation based on a determination that the LTM execution fails.

In step 810, the UE determines, based on the LTM configuration, whether a cell that is selected in the cell selection operation is an LTM candidate cell.

In step 812, the UE performs the LTM execution to the cell based on a determination that the cell is an LTM candidate cell and a determination that the applicability of the LTM configuration to recover from the failure of the LTM execution is enabled.

In step 814, the UE applies the LTM configuration for the cell.

In step 816, the UE transmits, to the cell, a random access preamble for performing a random access procedure.

In one embodiment, the UE, when (i) a command associated with the LTM execution is received and (ii) a CHO execution condition to a target cell is evaluated, performs the LTM execution to the target cell.

In one embodiment, the UE receives priority configuration information for mobility operations indicating an LTM operation, a HO operation, or a CHO operation, wherein the priority configuration information includes an indication indicating that a mobility operation among the mobility operations is prioritized.

In one embodiment, the UE receives priority configuration information for mobility operations indicating an LTM operation, a HO operation, and a CHO operation, wherein the priority configuration information comprises an indicator indicating a level of priority for each of the mobility operations.

In one embodiment, the UE receives (i) a plurality of mobility commands and (ii) priority configuration information; identifies based on the priority configuration information, a mobility command from the plurality of mobility commands that is prioritized; and executes the mobility command.

In one embodiment, the UE receives at least one mobility command; and prioritizes the at least one mobility command based on a condition associated with a target cell, wherein the condition is determined based on a TA of the target cell or a measurement result of RSRP received from the target cell.

In one embodiment, the UE receives a mobility command; deprioritizes the mobility command based on a prioritization configuration; reserves the deprioritized mobility command; and executes the reserved deprioritized mobility command when a mobility operation fails.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver configured to receive information related to (i) a layer 1 and layer 2 triggered mobility (LTM) configuration and (ii) an applicability of the LTM configuration to recover from a failure of an LTM execution; and
a processor operably coupled to the transceiver, the processor configured to:
determine, based on the information, whether the applicability of the LTM configuration to recover from the failure of the LTM execution is enabled,
determine whether the LTM execution fails,
perform a cell selection operation based on a determination that the LTM execution fails,
determine, based on the LTM configuration, whether a cell that is selected in the cell selection operation is an LTM candidate cell,
perform the LTM execution to the cell based on a determination that the cell is an LTM candidate cell and a determination that the applicability of the LTM configuration to recover from the failure of the LTM execution is enabled, and
apply the LTM configuration for the cell,
wherein the transceiver is further configured to transmit, to the cell, a random access preamble for performing a random access procedure.

2. The UE of claim 1, wherein the processor is further configured to, when (i) a command associated with the LTM execution is received and (ii) a conditional handover (CHO) execution condition to a target cell is evaluated, perform the LTM execution to the target cell.

3. The UE of claim 1, wherein:
the transceiver is further configured to receive priority configuration information for mobility operations indicating an LTM operation, a HO operation, or a CHO operation; and
the priority configuration information includes an indication indicating that a mobility operation among the mobility operations is prioritized.

4. The UE of claim 1, wherein:
the transceiver is further configured to receive priority configuration information for mobility operations indicating an LTM operation, a HO operation, and a CHO operation; and
the priority configuration information comprises an indicator indicating a level of priority for each of the mobility operations.

5. The UE of claim 1, wherein:
the transceiver is further configured to receive (i) a plurality of mobility commands and (ii) priority configuration information: and
the processor is further configured to:
identify, based on the priority configuration information, a mobility command from the plurality of mobility commands that is prioritized, and
execute the mobility command.

6. The UE of claim 1, wherein:
the transceiver is further configured to receive at least one mobility command;
the processor is further configured to prioritize the at least one mobility command based on a condition associated with a target cell; and
the condition is determined based on a timing advance (TA) of the target cell or a measurement result of reference signals received power (RSRP) received from the target cell.

7. The UE of claim 1, wherein:
the transceiver is further configured to receive a mobility command; and
the processor is further configured to:
deprioritize the mobility command based on a prioritization configuration,
reserve the deprioritized mobility command, and
execute the reserved deprioritized mobility command when a mobility operation fails.

8. A method of a user equipment (UE) in a wireless communication system, the method comprising:
receiving information related to (i) a layer 1 and layer 2 triggered mobility (LTM) configuration and (ii) an applicability of the LTM configuration to recover from a failure of an LTM execution;
determining, based on the information, whether the applicability of the LTM configuration to recover from the failure of the LTM execution is enabled;
determining whether the LTM execution fails;
performing a cell selection operation based on a determination that the LTM execution fails;
determining, based on the LTM configuration, whether a cell that is selected in the cell selection operation is an LTM candidate cell;
performing the LTM execution to the cell based on a determination that the cell is an LTM candidate cell and a determination that the applicability of the LTM configuration to recover from the failure of the LTM execution is enabled;
applying the LTM configuration for the cell; and
transmitting, to the cell, a random access preamble for performing a random access procedure.

9. The method of claim 8, further comprising, when (i) a command associated with the LTM execution is received and (ii) a conditional handover (CHO) execution condition to a target cell is evaluated, performing the LTM execution to the target cell.

10. The method of claim 8, further comprising receiving priority configuration information for mobility operations indicating an LTM operation, a HO operation, or a CHO operation, wherein the priority configuration information includes an indication indicating that a mobility operation among the mobility operations is prioritized.

11. The method of claim 8, further comprising receiving priority configuration information for mobility operations indicating an LTM operation, a HO operation, and a CHO operation, wherein the priority configuration information comprises an indicator indicating a level of priority for each of the mobility operations.

12. The method of claim 8, further comprising:
receiving (i) a plurality of mobility commands and (ii) priority configuration information:
identifying, based on the priority configuration information, a mobility command from the plurality of mobility commands that is prioritized; and
executing the mobility command.

13. The method of claim 8, further comprising:
receiving at least one mobility command; and
prioritizing the at least one mobility command based on a condition associated with a target cell,
wherein the condition is determined based on a timing advance (TA) of the target cell or a measurement result of reference signals received power (RSRP) received from the target cell.

14. The method of claim 8, further comprising:
receiving a mobility command;
deprioritizing the mobility command based on a prioritization configuration;
reserving the deprioritized mobility command; and
executing the reserved deprioritized mobility command when a mobility operation fails.

15. A base station (BS) in a wireless communication system, the BS comprising:
a processor configured to generate information indicating whether an applicability of a layer 1 and layer 2 triggered mobility (LTM) configuration to recover from a failure of an LTM execution is enabled is determined; and
a transceiver configured to transmit the information related to (i) the LTM configuration and (ii) the applicability of the LTM configuration to recover from the failure of an LTM execution,
wherein:
a cell selection operation is performed based on a determination that the LTM execution fails,
based on the LTM configuration, whether a cell that is selected in the cell selection operation is an LTM candidate cell is determined,
the LTM execution is performed to the cell based on a determination that the cell is the LTM candidate cell and a determination that the applicability of the LTM configuration to recover from the failure of the LTM execution is enabled,
the LTM configuration for the cell is applied, and
a random access preamble is transmitted to the cell for performing a random access procedure.

16. The BS of claim 15, wherein:
the transceiver is further configured to transmit priority configuration information for mobility operations indicating an LTM operation, a HO operation, or a CHO operation; and
the priority configuration information includes an indication indicating that a mobility operation among the mobility operations is prioritized.

17. The BS of claim 15, wherein:
the transceiver is further configured to transmit priority configuration information for mobility operations indicating an LTM operation, a HO operation, and a CHO operation; and
the priority configuration information comprises an indicator indicating a level of priority for each of the mobility operations.

18. The BS of claim 15, wherein:
the transceiver is further configured to transmit (i) a plurality of mobility commands and (ii) priority configuration information; s
based on the priority configuration information, a mobility command is identified from the plurality of mobility commands that is prioritized; and
the mobility command is executed.

19. The BS of claim 15, wherein:
the transceiver is further configured to transmit at least one mobility command;
the at least one mobility command is prioritized based on a condition associated with a target cell; and
the condition is determined based on a timing advance (TA) of the target cell or a measurement result of reference signals received power (RSRP) received from the target cell.

20. The BS of claim 15, wherein:
the transceiver is further configured to transmit a mobility command;
the mobility command is deprioritized based on a prioritization configuration;
the deprioritized mobility command is reserved; and
the reserved deprioritized mobility command is executed when a mobility operation fails.
